(19) United States
(12) Patent Application Publication
(10) Pub. No.: US 2022/0036146 A1
(43) Pub. Date: Feb. 3, 2022

(54) SCANNING DOCUMENT TO IDENTIFY RASTER-IMAGE PROCESSING (RIP)-REUSABLE ELEMENTS

(71) Applicant: Hewlett-Packard Development Company, L.P., Spring, TX (US)

(72) Inventor: Richard L Hilton, Boise, ID (US)

(73) Assignee: Hewlett-Packard Development Company, L.P., Spring, TX (US)

(21) Appl. No.: 17/297,678

(22) PCT Filed: Dec. 19, 2018
(86) PCT No.: PCT/US2018/066464

§ 371 Date: May 27, 2021

(51) Int. Cl. G06K 15/02

(52) U.S. Cl. CPC G06K 15/1822

(57) ABSTRACT

Scanning of a document that is to undergo raster-image processing (RIP) and then be printed is initiated to identify RIP-reusable elements within the document. The scanning of the document to identify the RIP-reusable elements is aborted prior to the scanning of the document having been completed. Responsive to determining that the scanning should be restarted based on a parameter, the scanning of the document to identify the RIP-reusable elements is restarted.

### BACKGROUND

While data has increasingly been consumed electronically, there remain many scenarios in which there is no substitution for printing electronically generated data. A source electronic document has to undergo processing so that an output device such as a printing device like a laser printer can actually form images on print media to print the document. The source document may be in a high-level page-description language (PDL), such as PostScript, PDF, XPS, or another PDL. The source document undergoes raster-image processing (RIP) to convert the document to a raster image, or bitmap, that the printing device directly uses to print the converted document onto print media.

### BRIEF DESCRIPTION OF THE DRAWINGS

FIG. 1 is a flowchart of an example method for determining when to abort scanning a document for raster-image processing (RIP)-reusable elements.

FIGS. 2A, 2B, and 2C are flowcharts of example methods for determining when to restart scanning a document for RIP-reusable elements.

FIG. 3 is a flowchart of an example method.

FIG. 4 is a diagram of an example non-transitory computer-readable data storage medium.

FIG. 5 is a diagram of an example system.

### DETAILED DESCRIPTION

As noted in the background section, a source electronic document in a page-description language (PDL) like PDF or another PDL undergoes raster-image processing (RIP) prior to and so that a printing device like a laser printer can print the document. Performing RIP on a document can be computationally intensive, which in turn means that performing RIP can be time consuming. While a printing device may have a relatively fast print engine (e.g., a laser printing mechanism), the device's ability to print quickly can depend on how fast the pages of a document can undergo RIP and the converted pages delivered to the print engine.

One technique to decrease RIP time is to identify RIP-reusable elements among the pages of a source electronic document to be printed. As such, rather than performing RIP each time an element is encountered on any page of a document, the element just has to undergo RIP one time. Subsequent occurrences of the element can then reuse the prior RIP of the element, instead of having to again perform RIP.

However, scanning a document to identify RIP-reusable elements itself takes time. If no—or relatively few—such elements are found in a source document to be printed, the resulting scanning-plus-RIP time ends up being longer than if RIP were performed without any initial reuse scanning being performed. One technique to resolve this issue is to abort a reuse scan if the scan is not identifying a sufficient number of document pages that include RIP-reusable elements.

More specifically, one technique compares the percentage of document pages scanned thus far that do not contain RIP-reusable elements, of the total number of document pages, to a threshold. For example, a document may include 1,000 pages. After 200 pages have been scanned, if all 200 pages do not contain RIP-reusable elements, then the percentage is 200/1,000=20%. If half of the 200 pages do not contain RIP-reusable elements, then the percentage is 100/1,000=10%. If the percentage is greater than the threshold, reuse scanning may be aborted.

However, setting the threshold can be difficult. For example, if all the pages of a document are unique (i.e., do not contain RIP-reusable elements), or all the pages include RIP-reusable elements, then the threshold may be set relatively low so that the reuse scan can abort quickly. The percentage of unique document pages, of the total number of document pages, will remain zero as pages of a document of which every page includes a RIP-reusable element are scanned. By comparison, the percentage of unique document pages will linearly increase towards 100% as pages of a document that contains no RIP-reusable elements are scanned.

While setting such a low threshold provides for timely termination of the reuse scanning process in these two opposing cases, such a low threshold can prematurely terminate reuse scanning in other cases that may frequently occur. For example, a document may include copies of a two-sided label, where the first side is unique for each copy (e.g., including a different delivery address, a different product bar code, and so on), and the second side is the same for each copy (e.g., including information regarding a vendor or manufacturer). If the document includes 1,000 pages, or 500 labels, then this means that the threshold has to be set over 50% to ensure that reuse scanning does not prematurely terminate. However, such a high threshold results in over 500 pages of a 1,000-page document that contains no RIP-reusable elements having to be scanned before reuse scanning properly terminates.

Furthermore, documents themselves may be amalgamations. For example, multiple print jobs may be merged into a single source electronic document, or the content of a document may otherwise periodically change from the first page of the document to the last job of the document. As to RIP-reusable element scanning, this means that parts of the document may include pages with RIP-reusable elements, but other parts of the documents may include pages without RIP-reusable elements. Reuse scanning may thus terminate due to an initial part of a document not containing sufficient RIP-reusable elements, even though a subsequent document part includes many RIP-reusable elements.

Techniques described herein ameliorate these shortcomings. A threshold can be set in correspondence with the rate of identifying unique pages within a document, as opposed to in correspondence with the percentage of unique pages identified so far of the total number of document pages. For example, a threshold may be set so that for every N pages that are scanned, a maximum of M pages that contain no RIP-reusable elements are permitted. If of N pages, reuse scanning identifies more than M unique pages, then the scan is aborted. Otherwise, scanning continues with the next N pages, where again if more than M pages that contain no unique pages are identified within these next N pages are identified, then scanning is aborted.

This approach can quickly terminate reuse scanning of a document that contains few or no RIP-reusable elements, while not prematurely terminating the scan of a document that has periodic reuse behavior, such as the two-sided label example that has been described. If documents with random reuse behavior is expected—i.e., documents in which there is no periodicity as to the presence of RIP-reusable elements—then N and M may be proportionally increased so that more pages of a document are scanned prior to termination. For example, if periodicity is expected, M and N may be set to three and five, respectively, whereas if periodicity is not expected, but the same base percentage M/N is desired, then M and N may be both increased by a factor of, say, four, to twelve and twenty, respectively.

Furthermore, even when reuse scanning has been aborted, reuse scanning may be restarted, based on a parameter. As one example, a less computational scan may continue once reuse scanning has been aborted, to identify a change in content in the document that warrants restarting reuse scanning. For instance, within the first N=10 pages of a document, say, M=6 unique pages may be identified, resulting in termination of the reuse scanning. A less computationally taxing—and thus faster—scan of subsequent pages of the document may continue. If at, say, page 152 of the document a change in content is identified via this continued scan, then reuse scanning begins again at page 152. Therefore, the benefits of RIP element reuse accrue even with source electronic documents that are amalgamations of different print jobs or otherwise have different types of content.

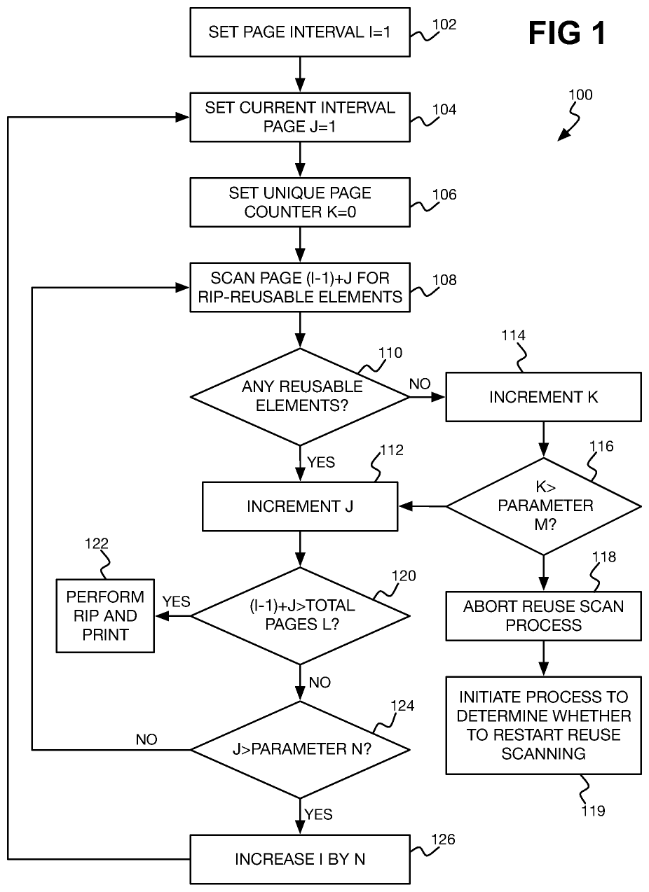

FIG. 1 shows an example method 100 for determining when to abort scanning a document for RIP-reusable elements. The method 100 can be performed by a computing device communicatively connected to a printing device, or by the printing device itself. The method 100 can be implemented as a non-transitory computer-readable data storage medium storing program code executable by a processor, such as that of a computing device or a printing device.

The method 100 is performed in relation to a source electronic document that is to undergo RIP so that a printing device can print the resulting converted document. The source document may be in a high-level PDL, such as PDF, PostScript, XPS, or another PDL. The PDL may specify different types of elements, such that each page of the document includes a number of such elements. Each element on a document page has to undergo RIP before the document can be printed.

A RIP-reusable element, which can also be referred to as a reusable element, is an element having more than one occurrence and whose RIP results are not affected by other elements that vary each time the element is used (such as, for example, transparency blending between the repeated reusable element and a non-repeated element). Therefore, such an element just has to undergo RIP once. Subsequent occurrences of the element within the document—on the same page or on different pages—can reuse the converted element. That is, when RIP is performed on pages including other occurrences of the element, instead of RIP having to be re-performed on the element, the prior RIP of the element can be (re)used.

Pages of the document that include any RIP-reusable element may be referred to as reusable pages. Pages of the document that do not include any RIP-reusable elements may be referred to as unique pages. The process of scanning a document for RIP-reusable elements can be referred to as reuse scanning.

In the technique of the example method 100, every N pages of the document are scanned for RIP-reusable elements. If in a given N pages there are more than M unique pages, then reuse scanning is aborted. For example, if the first interval of document pages 1 through N includes no more than M unique pages, then the next interval of pages N+1 through 2N are scanned. If this interval does not include more than M unique pages, then the following interval of document pages 2N+1 through 3N are scanned, and so on.

The method 100 sets a current page interval I to 1 (102). The interval I denotes the first page of the current interval. Therefore, when subsequent intervals of N pages are scanned, I is set to N+1, 2N+1, and so on.

The method 100 sets a current interval page J within the current interval J to 1 as well (104). The page J identifies the pages of the current interval, from the first page 1 through the last page N of the interval. As an example, in the third interval beginning with page I=2N+1 of the document and ending at I=3N of the document, the page J still counts from 1 through N. That is, the page J is a relative counter within the current interval, and not an absolute counter within the document as a whole.

The method 100 sets a unique page counter K to zero (106). The unique page counter K denotes the number of pages within the current interval of the document that do not include any RIP-reusable elements. Therefore, at the beginning of every interval of N pages, the counter K is reset back to zero, and is incremented as unique pages within the current interval are identified.

Page (I−1)+J of the document is scanned for RIP-reusable elements (108). For example, when the first interval 1=1 is being processed, the first page (i.e., page 1) of the document is first scanned, since (I=1−1)+(J=1)=1. When the second interval I=N+1 is processed, page N+1 of the document is first scanned, since (I=N+1-1)+(J=1)=N+1. Scanning a page of the document for RIP-reusable elements is not limited to any particular technique, and may correspond to the type of the source electronic document (e.g., PDF, PostScript, and so on).

If the page that has just been scanned contains any RIP-reusable elements (110)—i.e., the page is reusable and is not unique—then the current interval page J is incremented by 1 (112). However, if the page is unique (110)—i.e., it does not include any RIP-reusable element—then the unique page counter K is incremented by 1 (114). If the number of unique pages K that have been identified in the current interval is not greater than M (116)—that is, no more than M unique pages have been counted thus far in the current interval—then the current page J is incremented by 1 (112).

However, if the number of unique pages K that have been identified in the current interval exceeds the number of permitted unique pages M within the current interval (116), then the reuse scan process is aborted (118). The method 100 continues by initiating a process to determine whether (and at what document page) to restart reuse scanning (119). Different techniques for determining whether to restart the reuse scan process are described later in the detailed description.

Once the current interval page J has been incremented (112), the method 100 checks to determine if all the pages of the source electronic document have been scanned for RIP-reusable elements. That is, the method 100 determines whether the document page most recently scanned is the last page of the document. The document has L pages, from one through L.

Therefore, if (I−1)+J is greater than the total number of pages L within the document (120), there are no more pages to scan for RIP-reusable elements. The method 100 continues by performing RIP and printing the converted document (122). The same device that performs the reuse scan process of the method 100 may also perform RIP on the document, or another device may perform RIP, with information as to which pages include RIP-reusable elements, and the identity of these elements, provided by the device that performed reuse scanning. The RIP of the document thus leverages the identified RIP-reusable elements to perform RIP more quickly. The same device that performs RIP may be the same device that actually prints the document (i.e., the printing device), or a device other than the printing device may perform RIP.

If there are more pages to scan for RIP-reusable element, however, then the method 100 checks to determine if all the pages of the current interval of N pages have been scanned. That is, the method 100 determines whether the document page most recently scanned is the last page of the current interval of N pages. If there are more pages within the current interval to scan (124)—i.e., if J is not greater than N—then the method 100 is repeated at part 108 with the next document page.

However, if the page most recently scanned is the last page of the current page interval (124)—i.e., if J is greater than N—then the method 100 increases the current page interval I by N (126). That is, the current page interval is advanced to (the first page of) the next page interval of N pages in the document. The method 100 is repeated at part 104, with the resetting of the current interval page J back to 1, to continue the reuse scan process at the first page of this next interval.

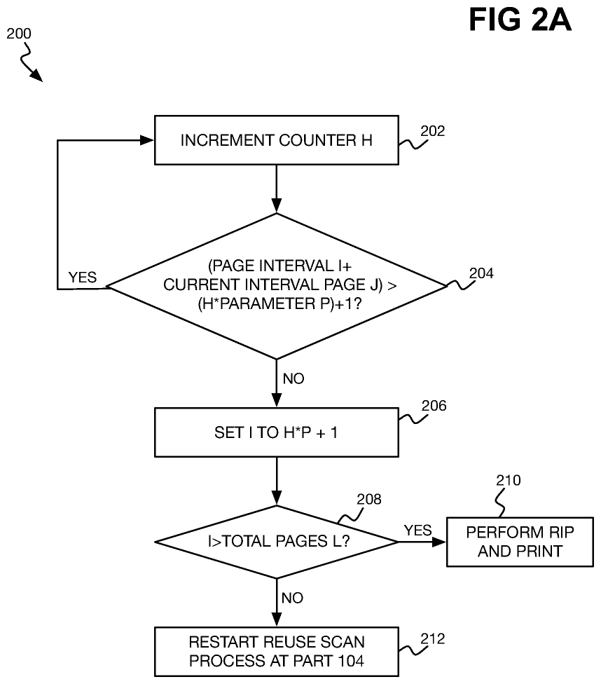

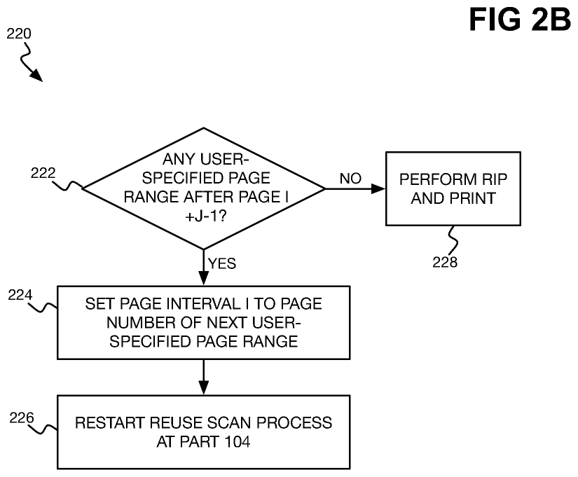

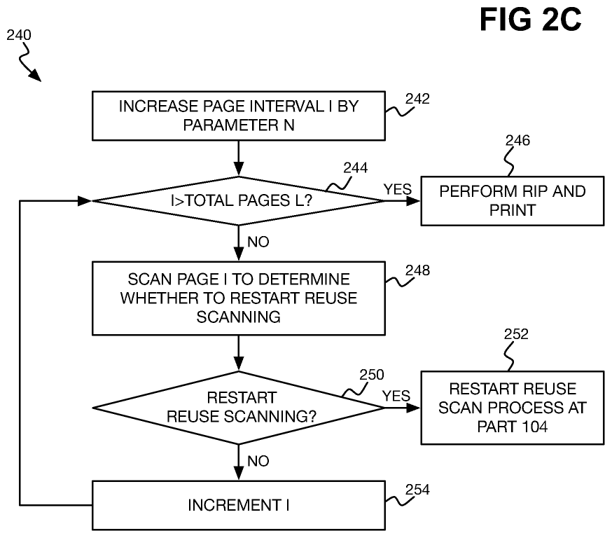

FIG. 2A shows an example method 200 for determining whether to restart RIP-reusable element reuse scanning. The method 200 can implement part 119 of the method 100. The method 200 can be performed by the same device that performs the method 100, or by another device. Like the method 100, the method 200 can be implemented as a non-transitory computer-readable data storage medium storing program code executable by a processor.

In the technique of the example method 200, reuse rescanning is restarted every P pages. The parameter P may be preconfigured. The parameter P is greater than the interval N. For instance, the document may have L=1,000 pages, and if there are more than M=6 unique pages in an interval of N=10 pages, reuse scanning is aborted. In the example method 200 of FIG. 2A, reuse scanning may as an example be restarted at the next interval of P=200 pages within the document that occurs subsequent to the document page at which reuse scanning was aborted. Thus, in this example, reuse scanning can be restarted at most 4 times.

Specifically, reuse scanning begins with the first interval of P=200 pages within the document. If reuse scanning is aborted during any of these first P=200 pages of the document, then reuse scanning is restarted with the next P=200 pages of the document (i.e., at page P=200+1=page 201 of the document). However, if, when reuse scanning began with the first interval of P=200 pages within the document, reuse scanning was aborted at page 295—i.e., within the second interval of P=200 document pages—then reuse scanning is restarted with the third interval of P=200 document pages (i.e., at page 2*(P=200)+1=page 401 of the document).

When a document is first scanned for reuse (i.e., when the method 100 of FIG. 1) is first performed, a counter H that counts the intervals of P pages is automatically reset to 0. In the method 200, then, the counter H is incremented by 1 (202), to advance the interval of P pages to the next such interval within the document. However, if this interval is not beyond the last page that was scanned for RIP re-usable elements, then the counter H is again incremented, until the next interval of P pages beyond the last scanned page is identified.

As such, if I+J is greater than H*P+1 (204), then the counter H is incremented again at part 202 of the method 200. The most recently scanned page is page I+J−1 of the document, and the next document page that has not been scanned is page I+J. The first page of the next interval of P pages is page H*P+1 of the document. This means if the next document page to be scanned is past the first page of the next interval of P pages (i.e., I+J>H*P+1), the this interval is skipped (i.e., H is again incremented by 1), and the following interval of P pages is considered until an interval is identified having a first page beyond the most recently scanned page.

Once the interval of P pages beyond the last scanned page has been identified (204), then I is set to the first page of this interval (206). That is, I is set to H*P+1. The process of incrementing the counter H until an interval of P pages is identified beyond the last scanned page can result in H*P+1 exceeding the number of L pages in the document. If I is greater than L (208), then, reuse scanning cannot be restarted, since there are no remaining interval of P pages within the document that include a page that has not yet been scanned for RIP-reusable elements. In this instance, the document can undergo RIP and the converted document printed (210), as in part 122 of the method 100. If I<L, though, the reuse scan process is restarted at part 104 of the method 100 (212), with the resetting of J to the first page of the interval of N pages identified by I.

FIG. 2B shows a second example method 220 for determining whether to restart RIP-reusable element reuse scanning. The method 220, like the method 200, can implement part 119 of the method 100. The method 220 can be performed by the same device that performs the method 100, or by another device. Like the methods 100 and 200, the method 220 can be implemented as a non-transitory computer-readable data storage medium storing program code executable by a processor.

In the technique of the example method 220, reuse rescanning is restarted at user-specified page ranges. For example, when generating a source electronic document to be printed, the user may explicitly identify different page ranges that each should be scanned for RIP-reusable elements. The user may, within a document of L=1,000 pages, explicitly tag that reuse scanning should occur within the range of pages 1 through 400, within the range of pages 401 through 700, and within the range of pages 701 through 1,000.

The method 220 thus determines whether there is any user-specified page range within the document beginning at a page beyond the most recently scanned page of the document. If there is not any user-specified page range beginning after this last scanned page (222), which is page I+J−1, then reuse scanning is not restarted. As such, RIP can be performed and the resulting converted document then printed (228), as in part 122 of the method 100. However, if there is a user-specified page range within the document beginning at a page beyond page I+J−1 (222), then I is set to the first page of this page range (224). The reuse scan process is restarted at part 104 of the method 100 (226).

FIG. 2C shows a third example method 240 for determining whether to restart RIP-reusable element reuse scanning. The method 240, like the methods 200 and 220, can implement part 119 of the method 100. The method 240 can be performed by the same device that performs the method 100, or by another device. Like the methods 100, 200, and 220, the method 240 can be implemented as a non-transitory computer-readable data storage medium storing program code executable by a processor.

In the technique of the example method 240, the page interval I can be increased by the parameter N (242), so that determining whether to restart reuse scanning begins at the next page interval within the document. In another implementation, the interval I may instead be set to the next page after the current page at which reuse scanning was aborted. That is, the interval I may be set to I+J (i.e., the interval I may be increased by J), where reuse scanning was aborted at page I+J−1.

If I is beyond the last page within the document, then reuse scanning is not restarted. Therefore, if I is greater than the total number of pages L within the document (244), RIP can be performed and the resulting converted document then printed (246), as in part 122 of the method 100. However, if I is not greater than L (244), then the method 240 continues by scanning page I to determine whether to restart use scanning (248).

In general, the scanning performed in part 248 is less processor intensive than the scanning of a page for RIP-reusable elements in part 108 of the method 100. Therefore, the scanning of part 248 occurs more quickly than the scanning of part 108. Scanning a page of a document to determine whether to restart reuse scanning can be performed in a number of different ways.

For example, the source electronic document may include a PDL-specified tag that denotes pages that are related to one another. Such as tag may specify a print job number, or another identifier of a print job, such as a globally unique identifier (GUID). Therefore, determining whether to restart scanning at a page is achieved by determining whether the value of this tag changes from a prior page to the current page. When a print job is generated, the computer program that generates the print job includes the tag within at least the first page of the print job. When the print job is merged with other print jobs to form the source electronic document, the tag thus demarcates the boundary between each pair of adjacent print jobs, so that reuse scanning can be performed for each print job included within the document.

As a second example, a page of the source electronic document may be scanned to determine whether a change in content of the document occurs at that page. As such, the RIP-reuse scan process is restarted at the page at which a change in content of the document occurs. For instance, the source electronic document may include high-level PDL objects, such as XObjects in the case of PDF-formatted documents. The scanning process of FIG. 2C can identify the XObjects referenced on each page, and detect when the usage of these objects changes significantly, such as by more than a threshold. If the number of pages within an interval of N pages referencing the objects in question decreases significantly, then reuse scanning is restarted. In one implementation, if in an interval of N pages the number of pages referencing the objects decreases from more than N−M pages to less than N−M pages (or to less than N−M−Q pages, where Q is a parameter), then reuse scanning is restarted.

In the former example, the software that generates the print job includes within each page of a print job—or at least within the first page of the print job—a tag with a value that identifies the print job. However, not all print job-generating software may include such a tag. By comparison, in the latter example, generation of the print job itself involves the generation of objects formatted in a given PDL, which can then be scanned to determine whether there is a significant change in content of a document including the print job. The change in content may occur between print jobs included in the same document, or may occur within a particular print job in the document.

If reuse scanning is to be restarted (250), then the reuse scan process is restarted at part 104 of the method 100 (252). If reuse scanning is not to be restarted (250), then I is incremented (254), and the method 240 is repeated at part 244 for this new value of I. While three different examples of determining when to restart reuse scanning have been described in relation to FIGS. 2A, 2B, and 2C, other approaches may also be employed to determine when to restart reuse scanning.

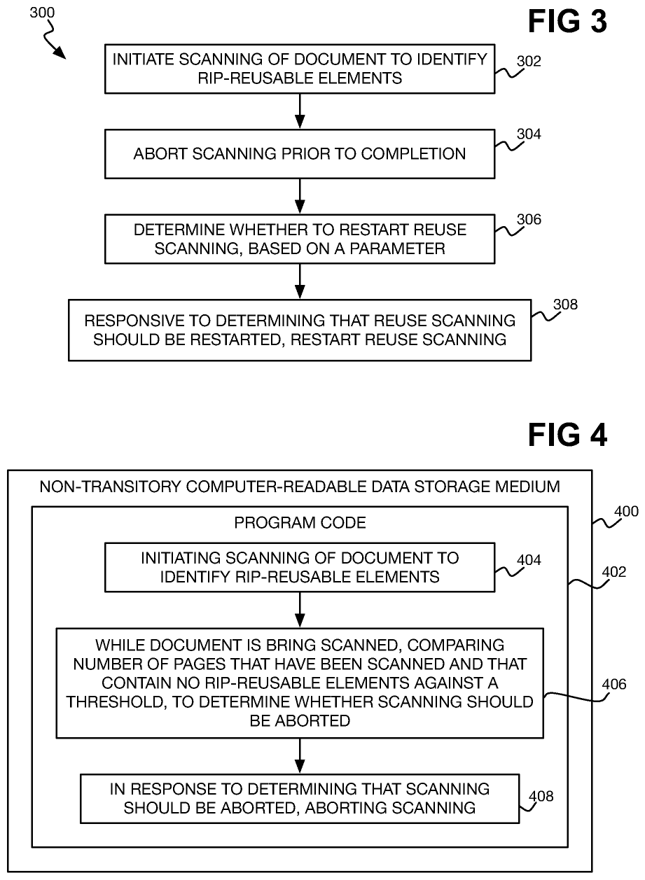

FIG. 3 shows an example method 300. The method 300 can be performed by a processor, such as the processor of a computing device communicatively connected to a printing device, the processor of the printing device itself, or the processor of another device. The method 300 initiates scanning of a document that is to undergo RIP and then be printed, to identify RIP-reusable elements within the document (302), but aborts the reuse scan process prior to completion (304). That is, reuse scanning is aborted prior to all the pages of the document having been scanned for RIP-reusable elements.

As such, the method 300 can include determining whether to abort reuse rescanning. For instance, the number of pages of the document that have already been scanned and that contain no RIP-reusable elements may be compared against a threshold. The threshold may correspond to the maximum number of pages M within a given interval of pages N that are permitted to contain no RIP-reusable elements, as has been described in relation to the method 100 of FIG. 1. If there are more than M unique pages within an interval of N pages, then reuse scanning is aborted.

The method 300 determines whether to restart reuse scanning, based on a parameter (306). The parameter may correspond to a specified number of pages of the document, as has been described in relation to the method 200 of FIG. 2A. The parameter may correspond to user-specified page ranges within the document, as has been described in relation to the method 220 of FIG. 2B. The parameter may correspond to a tag within the document that identifies related pages, or to a change in content within the document, as has been described in relation to the method 240 of FIG. 2C. Responsive to determining that reuse scanning should be restarted, therefore, the reuse scan process is restarted (308).

FIG. 4 shows an example non-transitory computer-readable data storage medium 400, which stores program code 402 executable by a processor to perform processing. The processing includes initiating the scanning of a document that is to undergo RIP and then be printed, to identify RIP-reusable elements within the document (404). The processing includes, while the document is being scanned, comparing the number of document pages that have already been scanned and that contain no RIP-reusable elements against a threshold, to determine whether scanning should be aborted (406). The threshold may correspond to the maximum number of pages M within a given interval of pages N that are permitted to contain no RIP-reusable elements, as has been described in relation to the method 100 of FIG. 1. The processing includes, in response to determining that reuse scanning should be aborted, aborting the reuse scan process (408).

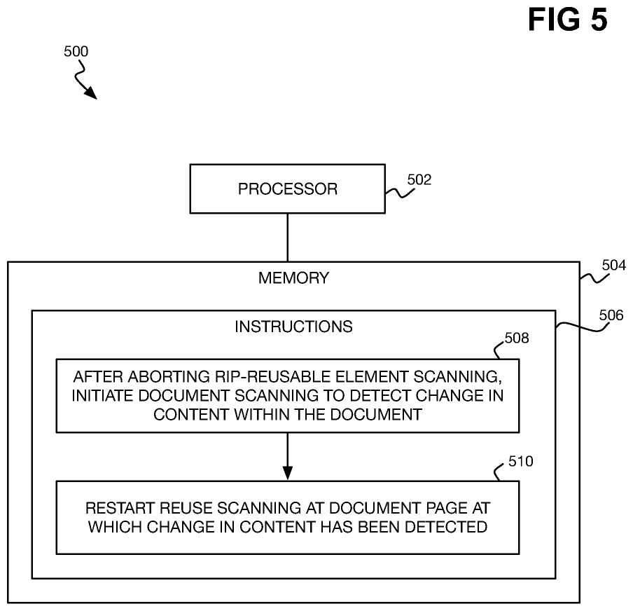

FIG. 5 shows an example computing system 500. The system 500 includes a processor 502 and a memory 504. The system 500 may include other components as well. For instance, the system 500 can include a print engine to print a document that has undergone RIP. The system 500 can include a RIP engine to perform RIP on a document, where the RIP engine leverages identified RIP-reusable elements within the document.

The memory 504 stores instructions 506, such as program code. The processor 502 can execute the instructions 506 to, after RIP-reusable element scanning has already been aborted, initiate scanning of the document that is to undergo RIP and then be printed, to detect a change in content within the document (508), as has been described relation to the method 240 of FIG. 2C. For example, the change in usage of a document object, greater than a threshold, may be detected. The processor 502 can execute the instructions to restart RIP-reusable element scanning at the document page at which the change in content has been detected (510), as has also been described in relation to the method 240.

The techniques described herein thus improve the capabilities of a computing device by improving the performance of such a device in readying a source electronic document for printing. That is, the techniques reduce the length of time needed to perform RIP, by identifying RIP-reusable elements within the document. More specifically, the techniques improve the RIP-reusable element identification process, by restarting this process after it has been aborted. As such, printing performance itself is improved, because the length of time between when printing of a source electronic document is initiated and when printing of the document actually starts is decreased. Such improvement in the capabilities of a computing device—which can be a printing device itself—provide a concrete improvement in printing technology.

We claim:

1. A method comprising:
initiating, by a processor, scanning of a document that is to undergo raster-image processing (RIP) and then be printed, to identify RIP-reusable elements within the document;
aborting, by the processor, the scanning of the document to identify the RIP-reusable elements, prior to the scanning of the document having been completed; and
responsive to determining that the scanning should be restarted based on a parameter, restarting, by the processor, the scanning of the document to identify the RIP-reusable elements.

2. The method of claim 1, further comprising:
initiating, by the processor, the RIP of the document, each RIP-reusable element undergoing the RIP once to generate a corresponding rasterized element that is reused for every instance of the RIP-reusable element identified within the document; and
causing, by the processor, printing of the document as has undergone the RIP.

3. The method of claim 1, further comprising:
while the document is being scanned to identify the RIP-reusable pages, determining, by the processor, whether the scanning of the document should be aborted, by comparing a number of pages of a current interval of pages of a plurality of intervals of pages of the document that have already been scanned and that contain no RIP-reusable elements against a threshold.

4. The method of claim 3, wherein the threshold corresponds to a maximum number of pages of a given number of pages that have been scanned that are permitted to contain no RIP-reusable elements without aborting the scanning of the document.

5. The method of claim 1, further comprising:
after aborting the scanning of the document, determining, by the processor, whether the scanning should be restarted, based on the parameter.

6. The method of claim 5, wherein the parameter comprises a specified number of pages of the document,
and wherein determining whether the scanning should be restarted comprises determining that the scanning should be restarted at a next multiple of the specified number of pages within the document.

7. The method of claim 5, wherein the parameter comprises user-specified page ranges within the document,
and wherein determining whether the scanning should be restarted comprises determining that the scanning should be restarted at a next user-specified page range within the document.

8. The method of claim 5, wherein the parameter comprises a tag within the document identifying related pages within the document,
and wherein determining whether the scanning should be restarted comprises determining that the scanning should be restarted at a page within the document at which a value of the tag changes.

9. The method of claim 5, wherein the parameter comprises a change in content within the document greater than a threshold,
and wherein determining whether the scanning should be restarted comprises determining that the scanning should be restarted at a page within the document at which a next change in content occurs.

10. The method of claim 9, wherein determining whether the scanning should be restarted comprises:
scanning the document to identify the page within the document at which the next change in content,
wherein the scanning of the document to identify the page at which the next change in content occurs is less processor intensive than the scanning of the document to identify the RIP-reusable elements.

11. A non-transitory computer-readable data storage medium storing program code executable by a processor to perform processing comprising:
initiating scanning of a document that is to undergoing raster-image processing (RIP) and then be printed, to identify RIP-reusable elements within the document;
while the document is being scanned, determining, by the processor, whether the scanning of the document should be aborted, by comparing a number of pages of the document that have already been scanned and that contain no RIP-reusable elements against a threshold; and
in response to determining that scanning of the document should be aborted, aborting the scanning of the document,
wherein the threshold corresponds to a maximum number of pages of a given number of pages that have been scanned that are permitted to contain no RIP-reusable elements without aborting the scanning of the document.

12. The non-transitory computer-readable data storage medium of claim 11, wherein determining whether the scanning of the document should be aborted by comparing the number of pages a current interval of pages of a plurality of intervals of pages of that have already been scanned and that contain no RIP-reusable elements against the threshold is performed after each page of a plurality of pages of the document has been scanned.

13. A computing system comprising:
a processor; and
a memory storing instructions executable by the processor to:
after scanning of a document that is to undergo raster-image processing (RIP) and then be printed to identify RIP-reusable elements within the document has been aborted, initiate scanning of the document to detect a change in content within the document greater than a threshold; and
restart scanning of the document to identify the RIP-reusable elements at a page of the document at which the change in content greater than the threshold has been detected.

14. The computing system of claim 13, wherein the scanning of the document to identify the page at which the change in content occurs is less processor intensive than the scanning of the document to identify the RIP-reusable elements.

15. The computing system of claim 13, wherein scanning the document to detect the change in content comprises scanning the document to detect a change in usage of a document object greater than the threshold.
